(19) United States
(12) Patent Application Publication
(10) Pub. No.: US 2017/0178070 A1
(43) Pub. Date: Jun. 22, 2017

(54) DATA ANALYSIS FOR DISPATCH SCHEDULING OPTIMIZATION IN THE PRESENCE OF TIME CONSTRAINTS

(71) Applicant: SAP SE, Walldorf (DE)

(72) Inventors: Mengjiao Wang, Shanghai (CN); Lucia Chen, Shanghai (CN); Eva Hu, Shanghai (CN); Wen-Syan Li, Shanghai (CN)

(21) Appl. No.: 14/976,592

(22) Filed: Dec. 21, 2015

(51) Int. Cl. G06Q 10/08; G06Q 10/06

(52) U.S. Cl. CPC G06Q 10/0832; G06Q 10/06314

(57) ABSTRACT

A capacity verifier accesses an inventory database and a vehicle database, based on at least one of a plurality of perishable good orders to be delivered by a plurality of delivery vehicles to a plurality of delivery sites. A dispatch schedule generator generates an initial dispatch schedule in which each of the plurality of delivery vehicles is individually scheduled for delivery to at least one of the plurality of delivery sites to define a delivery assignment, each delivery assignment being subject to an associated expiration time window for the perishable good being delivered. A dispatch schedule optimizer executes an iterative updating of an initial dispatch schedule wherein, in each iteration, at least one delivery assignment is altered and a resulting dispatch schedule is evaluated relative to associated expiration time windows, until an optimized dispatch schedule is obtained.

### TECHNICAL FIELD

This description relates to data analysis for predictive scheduling.

### BACKGROUND

High volumes of data are captured, stored, and available for use in various types of decision-making. However, it is often difficult or impossible for human users of such data to interpret and apply the data, and to engineer computers to operate based on the data, and in a manner that optimizes use of the available data.

For example, computers are often used in various types of scheduling operations, and many such scheduling operations are straightforward. In some contexts, however, it is difficult or impossible to make large-scale, accurate, and/or timely scheduling decisions, particularly when certain scheduling constraints exist, and/or when a large number of scheduling variables are present.

For example, some scheduling data relates to scheduling operations with time constraints. In particular, scheduling shipments of fresh fruit or other spoilable goods will be subject to such time constraints, including, e.g., the scheduling of shipments of concrete (which potentially hardens over time while in transit), or other transported goods having time-limited qualities.

### SUMMARY

The present description provides data analysis to predict and control schedules of vehicles that are transporting goods in a time-constrained environment, such as perishable goods. The data analysis relies on available data characterizing the type and quantity of the perishable goods to be delivered, as well as data characterizing orders or other (past, present, or future) requests for various quantities of the perishable goods. The data analysis also analyzes data characterizing the transport vehicles to be scheduled, a nature and extent of the time constraints associated with the perishable nature of the goods being scheduled, and other factors.

Through predictive data analysis, the above and other types of data may be used to obtain an initial solution, and then to optimize the solution using an iterative updating algorithm that, e.g., randomly changes scheduling parameters and evaluates resulting schedules. The iterative updating algorithm may continue until some termination condition is reached.

The results may be used to determine whether to accept a shipment order, and/or may be used to control a schedule of a truck, ship, or other vehicle transporting the associated perishable goods. As a result, the perishable goods may be delivered in a manner that prevents the perishing thereof during transit, while optimizing a speed, reliability, and or profit of the transportation process.

According to one general aspect, a computer program product is tangibly embodied on a non-transitory computer-readable storage medium and includes instructions that, when executed, are configured to cause at least one computing device to receive a plurality of perishable good orders to be delivered by a plurality of delivery vehicles to a plurality of delivery sites, wherein a perishable good specified in the plurality of perishable good orders is associated with an expiration time window measured from a time of production of the perishable good. When executed, the instructions are further configured to cause the at least one computing device to verify, for each order, satisfaction of a plurality of capacity constraints associated therewith, and generate an initial dispatch schedule in which each of the plurality of delivery vehicles is individually scheduled for delivery to at least one of the plurality of delivery sites to define a delivery assignment, each delivery assignment being subject to the associated expiration time window for the perishable good being delivered. The instructions, when executed, are further configured to cause the at least one computing device to execute an iterative updating of the initial dispatch schedule wherein, in each iteration, at least one delivery assignment is altered and a resulting dispatch schedule is evaluated relative to associated expiration time window, and terminate the iterative updating upon detection of a termination condition.

According to another general aspect, a method includes receiving a plurality of perishable good orders to be delivered by a plurality of delivery vehicles to a plurality of delivery sites, wherein a perishable good specified in the plurality of perishable good orders is associated with an expiration time window measured from a time of production of the perishable good. The method further includes verifying, for each order, satisfaction of a plurality of capacity constraints associated therewith, and generating an initial dispatch schedule in which each of the plurality of delivery vehicles is individually scheduled for delivery to at least one of the plurality of delivery sites to define a delivery assignment, each delivery assignment being subject to the associated expiration time window for the perishable good being delivered. The method further includes executing an iterative updating of the initial dispatch schedule wherein, in each iteration, at least one delivery assignment is altered and a resulting dispatch schedule is evaluated relative to associated expiration time windows, and terminating the iterative updating upon detection of a termination condition.

According to another general aspect, a system includes instructions recorded on a non-transitory computer-readable storage medium, and executable by at least one processor. The system includes a capacity verifier configured to access an inventory database and a vehicle database, based on at least one of a plurality of perishable good orders to be delivered by a plurality of delivery vehicles to a plurality of delivery sites, wherein a perishable good specified in the plurality of perishable good orders is associated with an expiration time window measured from a time of production of the perishable good. The system further includes a dispatch schedule generator configured to generate an initial dispatch schedule in which each of the plurality of delivery vehicles is individually scheduled for delivery to at least one of the plurality of delivery sites to define a delivery assignment, each delivery assignment being subject to the associated expiration time window for the perishable good being delivered, and further configured to access a schedule database to store the initial dispatch schedule. The system further includes a dispatch schedule optimizer configured to execute an iterative updating of the initial dispatch schedule wherein, in each iteration, at least one delivery assignment is altered and a resulting dispatch schedule is evaluated relative to associated expiration time windows, and further configured to access the schedule database and store a currently-best dispatch schedule, as compared to preceding iteration, and further configured to terminate the iterative updating upon detection of a termination condition.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for dispatch scheduling in the presence of time constraints.

FIG. 2 is a flowchart illustrating example implementations of the system of FIG. 1.

FIG. 3 is a flowchart illustrating more detailed example implementations of the system of FIG. 1.

FIG. 4 is a flowchart illustrating more detailed example implementations of the flowchart of FIG. 3.

FIG. 5 is a timing diagram illustrating a concrete delivery example implementation of FIG. 1.

FIG. 6 is a Gantt chart illustrating truck availability in the example implementation for concrete delivery of FIG. 5.

### DETAILED DESCRIPTION

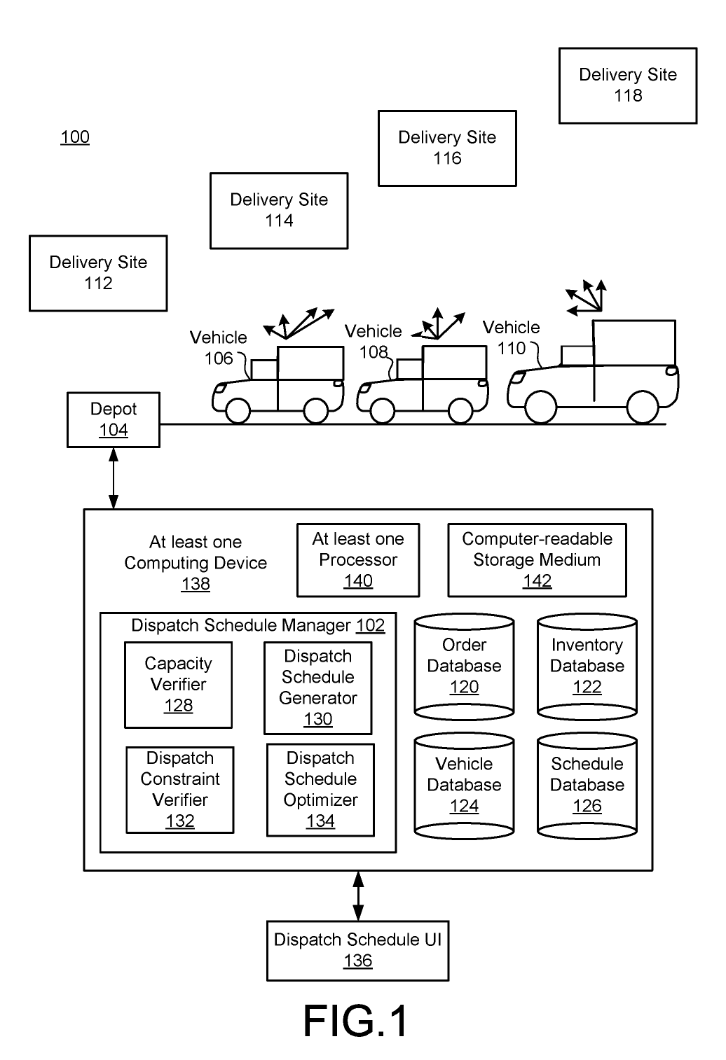

FIG. 1 is block diagram of a system 100 for dispatch scheduling in the presence of time constraints. In FIG. 1, a dispatch schedule manager 102 is configured to manage dispatch scheduling for a depot 104 from which a plurality of delivery vehicles, illustrated as vehicles 106, 108, 110, are scheduled and dispatched for delivery to a plurality of delivery sites, represented in the example of FIG. 1 as delivery sites 112, 114, 116, and 118.

In the example of FIG. 1, the vehicles 106-110 are assumed to be delivering goods that are subject to time constraints in the delivery thereof, such as perishable goods, or other goods that will have little to no value to recipients at the delivery sites 112-118 if received outside of relevant time windows. Further, the deliveries are assumed to be subject to a number of different delivery variables that may impose additional constraints on formulating dispatch schedules for the vehicles 106-110. Such delivery variables and associated constraints are described in detail below, but, in general, may include, for example, delivery capacities of the individual vehicles 106, 108, 110, travel distances/times between the depot and the various delivery sites 112-118, and inventory/production constraints for goods being produced and loaded onto the various vehicles 106-110 at the depot 104.

In operation, the dispatch schedule manager 102 is configured to execute dispatch scheduling for the vehicles 106-110 relative to the delivery sites 112-118, in a manner that considers the various variables and constraints just referenced, as well as other variables/constraints not explicitly mentioned, and including time constraints related to spoilage or expiration of perishable goods being delivered. In this regard, the dispatch schedule manager 102 of FIG. 1 meets a long-sought but unmet need in the field of dispatch scheduling, including performing large-scale data analysis to obtain a reduction or elimination of spoilage or expiration of perishable goods, along with associated increases in profit obtained by an operator of the depot 104, as well as customer satisfaction experienced by operators of the various delivery sites 112-118.

For example, in conventional dispatch scheduling systems, it is necessary to account for significant overages in terms of a quantity of perishable goods that are purchased, produced, and delivered, due to an expectation that a corresponding quantity of such perishable goods will experience spoilage prior to successful delivery thereof. In contrast, the dispatch schedule manager 102 is configured to reduce, minimize, or eliminate such requirements for delivery overages, in a manner that is straightforward for an operator of the dispatch schedule manager 102.

The above-referenced need for optimized dispatch scheduling relates to a nature of such dispatch scheduling, particularly in the context of perishable goods, and in context in which a relatively large number of delivery vehicles and/or delivery sites must be considered, and/or in the presence of a variety of the types of delivery variables referenced above and described in detail below. For example, in a most rudimentary example, such as a single delivery vehicle delivering to one or two delivery sites, it may be straightforward for a human operator to perform dispatch scheduling. However, even small increases in the various delivery variables and constraints, such as increases in a number of available delivery vehicles and/or delivery sites, quickly renders dispatch scheduling optimization beyond an ability of the human operator, particularly when some or many of the delivery variables are dynamically changing over time.

For example, as represented conceptually by the varying sizes of the delivery vehicles 106-110 illustrated in FIG. 1, it may occur that the various delivery vehicles being used have different loading capacities, and are therefore capable of delivering varying amounts of the perishable goods being delivered. Meanwhile, as also represented conceptually in the example of FIG. 1 by the varying distances of the delivery sites 112-118 from the depot 104, it may occur that the various delivery vehicles 106-110 are required to travel different distances for different deliveries.

As referenced above, and described in detail below, many other such delivery variables and associated constraints may be present, such as a quantity and timing of availability of inventory of the perishable goods being delivered, or a time required to load the perishable goods at the depot 104, and the time required to unload the perishable goods at a relevant one of the delivery sites 112-118. Nonetheless, even in the simplified example of FIG. 1, it may be observed that dispatch scheduling optimization cannot be performed by a human operator in a manner that is sufficiently fast, reliable, or otherwise optimized.

For example, possible combinations of delivery vehicles and assigned delivery sites rose exponentially with addition of either more delivery vehicles and/or more delivery sites. Moreover, such expediential growth is accelerated by the fact that delivery assignments of delivery vehicles to delivery sites do not necessarily have a 1:1 correspondence. For example, depending on a size of an order for perishable goods received by a given delivery site, and on a current availability of the various delivery vehicles 106-110, it may be possible or necessary to deliver a single order using two or more delivery vehicles. Conversely, for relatively smaller orders and/or for relatively larger available delivery vehicles, it may be necessary or feasible to deliver two or more orders at two or more delivery sites using a single delivery vehicle. Put another way, a ratio of delivery vehicles to delivery sites in a given delivery assignment may be 1:1, n:1, or 1:n, or n:n.

Further, as just referenced, and as described in more detail below, a current, real-time availability of individual delivery vehicles may need to be considered. For example, even if the delivery vehicle 110 provides an optimized delivery option for delivery of an order recently received from the delivery site 112, it may occur that the delivery vehicle 110 is already en route to, e.g., the delivery site 118. Consequently, the optimal delivery vehicle 110 may not be available for a currently-required delivery to the delivery site 112, and, moreover, may not be available until after a time that would be insufficient to meet a time constraint associated with the required delivery to the delivery site 112.

In other examples, and depending on the context of implementation of the system 100 as described in more detail below, the various delivery vehicles 106-110 may be required to navigate traffic on intervening roads, or otherwise deal with related transit difficulties. Such transit difficulties add additional delivery variables, many of which also occur in real-time. For example, one of the delivery vehicles may experience a breakdown, malfunction, traffic jam, accident, or other delay in its delivery assignment, thereby necessitating an updated optimization, or re-optimization, of an existing dispatch schedule.

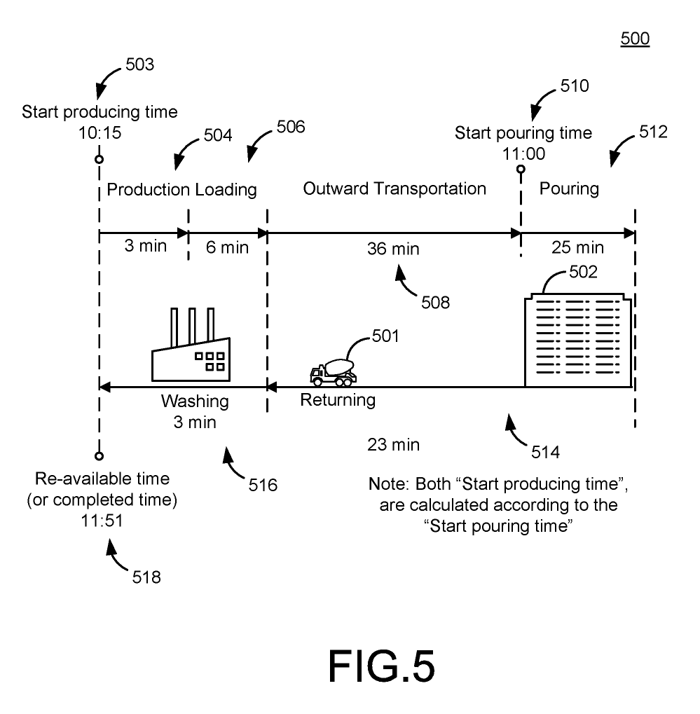

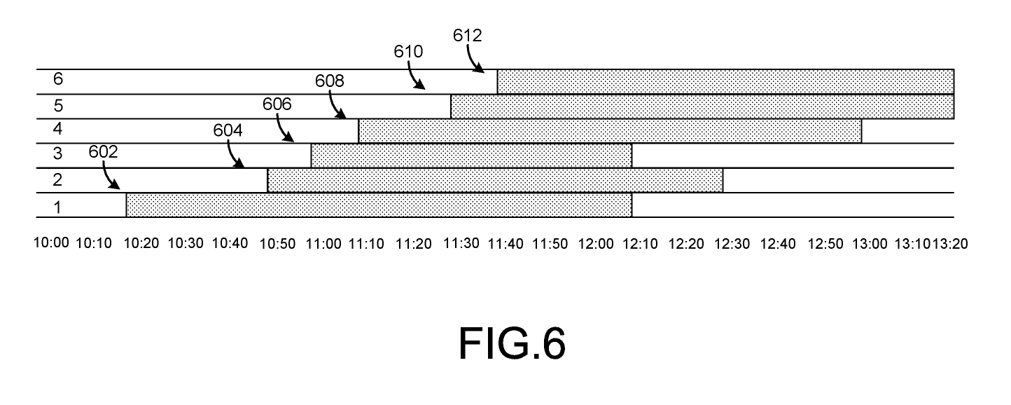

Still further, as already referenced, a nature and extent of relevant delivery variables and constraints will vary in and among the many different contexts in which the system 100 of FIG. 1 may be implemented. That is, dispatch scheduling occurs in a large number of widely varying contexts, including deliveries of perishable goods, such as fresh food, or delivery of concrete (which, as explained in detail below with respect to FIGS. 5 and 6), may experience spoilage or expiration in the sense that the concrete being delivered may harden prematurely, and become unusable to an operator of a corresponding delivery site. Thus, the terms spoilage, perishable, expiration, or similar terms, as used herein, should be understood to refer generally to any type of good being delivered that may become partially or completely unusable or undesirable to a recipient thereof after some predetermined quantity of time. The quantity of time may be dictated by one or more factors present in a given context, such as a nature of the good being delivered, and/or a contractual obligation regarding delivery time agreed to by the operators of the depot 104 and each of the various delivery sites 112-118.

For the sake of non-limiting example, the various delivery contexts referenced above may include virtually any delivery of goods from the depot 104, where the depot 104 represents any central location from which the goods are disbursed for delivery. For example, the depot 104 may represent a factory, warehouse, shipyard, or any location at which the plurality of delivery vehicles 106-110 may be housed.

Consequently, it will be appreciated that the delivery vehicles 106-110 themselves may represent any suitable vehicle with a loading capacity suited to storing and transporting the goods in question. Thus, the delivery vehicles 106-110 may represent, e.g., trucks, trains, automobiles, bicycles, boats, or other vehicles, or combinations thereof. Thus, and again by way of non-limiting example, the various industries in which the system 100 may be implemented include food services industry, postal; or package deliveries, taxi or other passenger or courier services, medical or emergency deliveries or services, and various types of home services (e.g., plumbing, electrical, or other types of home repair or maintenance).

In the various example implementation contexts referenced above, it is assumed that appropriate data collection systems are in place for the timely collection and storage of delivery-related data. For example, the various vehicles 106-110 may be equipped with a global positioning system (GPS) and associated transmitter for transmitting current location information to the depot 104. In other examples, human operators of the vehicles 106-110 may be required to report position and other delivery-related information (e.g., vehicle malfunction) to a human operator at the depot 104, who may then be equipped to enter such delivery data into a corresponding database, as described in detail below. Further, systems may be in place at some or all of the delivery sites 112-118 to facilitate accurate and timely reporting of delivery data. For example, goods being delivered may be equipped or associated with radio frequency ID (RFID) tags, barcodes, or other tracking technology, and equipment at the various delivery sites 112-118 (operated or provided by one or both of delivery site personnel or vehicle personnel, or operated automatically) may be configured to detect and report successful delivery and receipt the transported goods.

Further, some delivery-relevant data may be entered by personnel at the depot 104, or through the use of other appropriate techniques, prior to a delivery of relevant perishable goods, and updated when the delivery of the associated perishable goods occur. For example, inventory data may be entered upon receipt of inventory, and updated to reflect inventory reductions associated with orders and deliveries of ordered quantities of the perishable goods. Thus, in these and other examples, various types of delivery data may be reported and collected for use by the dispatch schedule manager 102.

In FIG. 1, as shown, an order database 120 represents a database storing various orders received from, or on behalf of, the various delivery sites 112-118. As may be appreciated, such orders will typically include various types of order-relevant data, such as a quantity or type of the goods to be delivered, and any associated timing constraints or other delivery conditions. Orders may be received and entered in the order database 120 using any known or future technique, including, e.g., entry of each order into a website operated by an operator of other user of the depot 104.

Meanwhile, as referenced, an inventory database 122 may be utilized to store a current available inventory of the perishable goods to be delivered. The data structure of the inventory database 122 may be created and maintained using a variety of known or future database management techniques. The inventory data will vary appropriately based on the type of inventory being stored, but will generally be understood to include any necessary and relevant delivery conditions. For example, in the context of a delivery of fresh food, produce, or flowers, relevant spoilage times and associated temperatures that must be maintained within a delivery vehicle during transportation to maximize the spoilage time, may be stored.

A vehicle database 124 represents a database storing information regarding the various vehicles, represented by the vehicles 106-110. As such, the vehicle database 124 may include information regarding a loading capacity of each vehicle, a loading/unloading time for each vehicle, relative to any type of perishable good that may be delivered, and various other relevant delivery variables and constraints described herein. For example, the vehicle database 124 also may be used to store a unit cost characterizing relative delivery costs associated with individual ones of the vehicles 106-110. For example, all things being equal, a larger vehicle may have a lower unit cost than a smaller vehicle, since the larger vehicle is capable of delivering a larger quantity of goods in a single delivery. Of course, other factors may impact the unit cost metric, such as, for example, an age or condition of a given vehicle, or a type of vehicle, or a cost of fuel or other cost associated with operating the vehicle.

A schedule database 126 represents a database for storing past, current, and predicted/planned dispatched schedules. As such, the schedule database 126 generally includes a plurality of delivery assignments associating one or more vehicles with one or more delivery sites for individual deliveries at specified times.

Although the various databases 120-126 are illustrated as separate, discrete databases for clarity and convenience in describing various functionalities and features thereof, it will be appreciated that it is also possible to implement the various database requirements described herein using a smaller or larger number of databases. Moreover, any suitable database technology may be utilized that provides sufficient speed and reliability to support operations of the dispatch schedule manager 102 as described herein. For example, database systems such as MySQL may be used. In particular implementations, end memory databases may be utilized when needed to process very large quantities of delivery data very quickly. Of course, various combinations of such database systems also may be used.

Thus, the one or more databases represented by the databases 120-126 are capable of storing and managing vast amounts of historical and current data related to dispatch scheduling for the system 100. Further, as described, the dispatch schedule manager 102 is configured to access and process data from the databases 120-126 in a manner that enables fast and efficient dispatch scheduling, in a manner that is beyond the capabilities of a human operator and/or conventional scheduling systems.

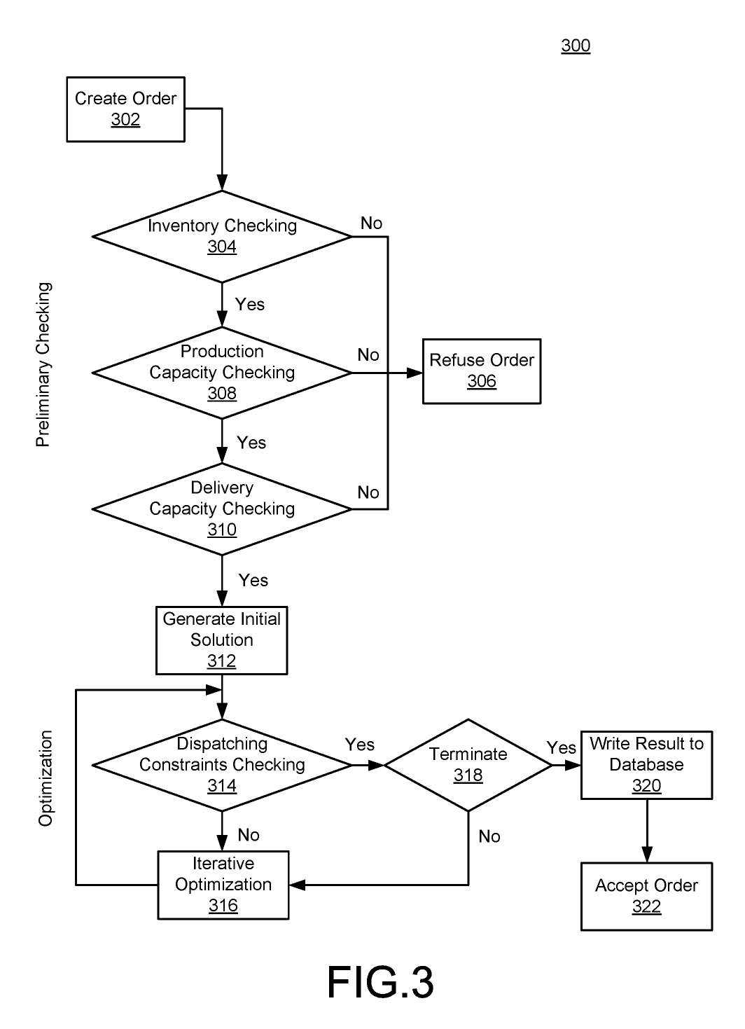

In more detail, as shown, the dispatch schedule manager 102 includes a capacity verifier 128. As described in detail below, e.g., with respect to FIG. 3, the capacity verifier 128 may be configured to verify various different types of capacity constraints, with respect to orders received and stored within the order database 120. For example, the capacity verifier 128 may verify that a sufficient quantity of raw materials or other inventory will be produced and available for loading at a time required for a specific delivery assignment. Similarly, the capacity verifier 128 may verify that sufficient machine, vehicular, and human resources will be available for subsequent production and loading of inventory goods at a time of a particular delivery assignment. In another example, the capacity verifier 128 may be configured to verify a delivery capacity defined with respect to available vehicles, loading capacities thereof, as well as human resources (e.g., drivers or other operators of the various vehicles to be used).

In the example of FIG. 1, the dispatch schedule manager 102 also includes a dispatch schedule generator 130 that is configured to generate an initial solution for the dispatch schedule for one or more of the orders received, and for which associated capacities have been verified by the capacity verifier 128. In other words, for the orders for which dispatch schedules are being generated, the dispatch schedule generator 130 will generate a number of delivery assignments specifying one or more of the vehicles 106-110 as being assigned to one or more of the delivery sites 112-118, each within specified time windows designed and chosen to be large enough to allow for a loading of the perishable goods, transportation thereof to the specified one or more delivery sites, unloading of the perishable goods at the one or more delivery sites, return of the one or more delivery vehicles to the depot 104, and, if necessary, preparation of the one or more delivery vehicles for receipt of a subsequent load (e.g., washing or rinsing of the delivery vehicle, or maintenance of the delivery vehicle).

In some examples, the initial dispatch schedule and associated delivery assignments may be generated essentially randomly, but subject to the various capacity requirements and dispatch constraints, as discussed below. In other example implementations, and depending on context, the dispatch schedule generator 130 may be configured to generate the initial dispatch schedule using a set of predefined rules, or appropriate algorithm.

For example, as described below with respect to the example of concrete delivery as described with respect to FIGS. 5 and 6, the dispatch schedule generator 130 may initially select delivery vehicles having the largest available loading capacity, and subsequently select delivery vehicles with relatively smaller loading capacities, based on the premise that the vehicles with larger loading capacities will have smaller unit costs, and should therefore be used preferentially when possible. Depending on the nature of the orders and of the delivery vehicles, and on the general delivery context of a particular implementation, other such assumptions may be made regarding preferential construction of the initial dispatch schedule. Such efforts may result in an initial dispatch schedule that is closer to an optimal dispatch scheduler than may be reached by an initially random placement of delivery assignments. On the other hand, as many of the scheduling operations of the dispatch schedule manager 102 will be non-linear and largely unpredictable in nature, resources assigned to generation of the initial dispatch schedule, and associated results, may vary.

Once the initial dispatch schedule has been generated, a dispatch constraint verifier 132 may be configured to ensure that the generated dispatch schedule and its associated delivery assignments all conform to the various dispatch constraints described herein. For example, the dispatch constraint verifier 132 will ensure that the generated dispatch schedule provides for delivery of perishable goods within an expiration time window associated with a spoilage or other expiration of the perishable goods.

Finally with respect to the dispatch schedule manager 102, a dispatch schedule optimizer 134 may be configured to receive the initial dispatch schedule, as verified by the dispatch constraint verifier 132, and thereafter make adjustments or changes to the various individual delivery assignments of the initial dispatch schedule. For example, as described in more detail below, the dispatch schedule optimizer 134 may randomly select a delivery assignment, and may alter one or more delivery vehicles included therein. Additionally, or alternatively, the dispatch schedule optimizer 134 may select one or more delivery assignments and alter a delivery site specified therein.

For example, in the simplified example of FIG. 1, an initial dispatch schedule may provide for a delivery assignment in which the vehicle 110, as the largest available vehicle, is assigned to deliver a first order to the delivery site 112, and a second order to the delivery site 114. Meanwhile, in its second delivery assignment, the vehicle 106 may be assigned to deliver a second order to the delivery site 116, while the vehicle 108 is assigned to deliver a third order to the delivery site 118. Thus, in operations of the dispatch schedule optimizer 134, the different delivery assignments may be varied. For example, the vehicle 110 may be assigned to deliver both orders to the delivery sites 116, 118, while the vehicle 106 is considered for delivery to the delivery site 112, and the vehicle 108 is considered for delivery to the delivery site 114. In yet another example, the vehicle 110 may be assigned to deliver orders to both the delivery site 112 and the deliver site 114, returned to the depot 104, and deliver remaining orders to the delivery site 116 and the delivery site 118, thereby leaving the delivery vehicles 106, 108 available for other orders.

As is apparent even from such simplified examples, a large number of possible solutions to the dispatch scheduling problem exist, and will vary widely over time, depending on the various delivery conditions, such as the relative sizes of the orders, the relative distances (and associated transportation costs) of the various delivery sites 112-118, the various loading capacities of the vehicles 106-110, and the various other delivery conditions described herein.

Nonetheless, by altering the delivery assignments as just described, or using related techniques, the dispatch schedule optimizer 134 may quickly generate dispatch schedules which are improvements over the initial dispatch schedule generated by the dispatch schedule generator 130. That is, the dispatch schedule optimizer 134 may rely on the dispatch constraint verifier 132 to ensure that the new, altered dispatch schedule complies with all relevant dispatch constraints, and may calculate whether an overall delivery cost, or other suitable metric, represents an improvement over the initial dispatch schedule. If so, the dispatch schedule optimizer 134 may store the resulting, improved dispatch schedule within a schedule database 126.

Whether the resulting dispatch schedule is an improvement over the initial dispatch schedule or not, the dispatch schedule optimizer 134 may proceed to generate a new, third dispatch schedule, e.g., by randomly altering the delivery assignments of the preceding dispatch schedule, or by randomly altering the delivery assignments of the original dispatch schedule. Again, the associated dispatch constraint for the new, third dispatch schedule may be verified by the dispatch constraint verifier 132, and associated delivery cost or other metric may be calculated by the dispatch schedule optimizer 134. Again, if the resulting dispatch schedule is the best dispatch schedule so far, it may be written to the schedule database 126 to serve as a benchmark for future iterations of the dispatch schedule optimizer 134, or, otherwise, may be discarded.

The dispatch schedule optimizer 134 may continue iterations of calculating new delivery assignments and verifying associated dispatch constraints thereof, until some termination condition is reached. For example, the termination condition may occur after a certain number of iterations, or when a certain cost threshold or other metric is reached. Additionally, or alternatively, the number of iterations conducted may be a function of a quantity of time available to make such calculations, as defined by delivery deadlines specified within the various received orders.

In the example of FIG. 1, a dispatch schedule user interface (UI) 136 may be provided for an operator of the dispatch schedule manager 102, to thereby enable the operator to configure the dispatch schedule manager 102, as well as to view outputs thereof. For example, the dispatch schedule UI 136 may be used to configure a manner in which the dispatch schedule manager 102 accesses and utilizes the various databases 120-126, or a manner in which the dispatch schedule optimizer 134 modifies the various delivery assignments from iteration to iteration, to provide a few non-limiting examples.

Further, as referenced, the dispatch schedule UI 136 may be configured to display outputs of the dispatch schedule manager 102. For example, as described in more detail below, the dispatch schedule UI 136 may be configured to illustrate a production schedule associated with the various delivery assignments, as well as the actual, resulting dispatch schedules themselves. In some implementations, the dispatch schedule UI 136 also may be configured to enable the operator thereof to modify and ultimately select a provided dispatch schedule, whereupon the selected dispatch schedule may be sent as actionable delivery assignments to be implemented by, e.g., operators of the depot 104 and/or operators of the various vehicles 106-110.

Finally in the example of FIG. 1, as illustrated, the dispatch schedule manager 102 is shown as being executed by at least one computing device 138, which itself includes at least one processor 140, as well as a non-transitory computer readable storage medium 142. That is, the at least one computing device 138 represents and includes various implementations in which two or more aspects of the dispatch schedule manager 102 and/or the various databases 120-126, may be implemented using two or more computing devices in communication with one another. For example, in some implementations, a first computing device may be located at the depot 104 and configured to perform certain functions that may require less computing power, such as the capacity verification operations of the capacity verifier 128. Meanwhile, other aspects of the dispatch schedule manager 102, and/or the various databases 120-126 (and associated database management systems) may be located and operated remotely, e.g., at a corporate headquarters or other corporate location associated with the depot 104, or at a third-party data and data services provider.

Somewhat similarly, the at least one processor 140 represents and includes the possibility of using two or more processors executing in parallel to perform operations of the dispatch schedule manager 102. For example, as described in more detail below, the various iterations conducted by the dispatch schedule optimizer 134 may be conducted in parallel, so as to reach a suitable or optimized dispatch schedule, or otherwise reach a termination condition for the iterations, as quickly and efficiently as possible.

Meanwhile, the non-transitory computer readable storage medium 142 represents any one or more storage mediums and associated devices or features that may be used to store instructions that, when executed by the at least one processor 140, perform the various functions of the dispatch schedule manager 102. Of course, the non-transitory computer readable storage medium 142 also may be understood to represent any desired or necessary storage medium for use in implementing the one or more databases 120-126.

Of course, it will also be appreciated that the at least one computing device 138 represents a highly simplified version of the various types of computing devices that may be used to implement the system 100 of FIG. 1. Accordingly, the at least one computing device 138 may represent virtually any computing device having sufficient computer capabilities to execute and provide the various features and functions described herein. As such, the at least one computing device 138 should also be understood to include any associated hardware or software that may be necessary or useful, including various types of network communication hardware/software, and various input/output peripherals (e.g., a monitor, screen, or other display utilized to provide the dispatch schedule UI 136.

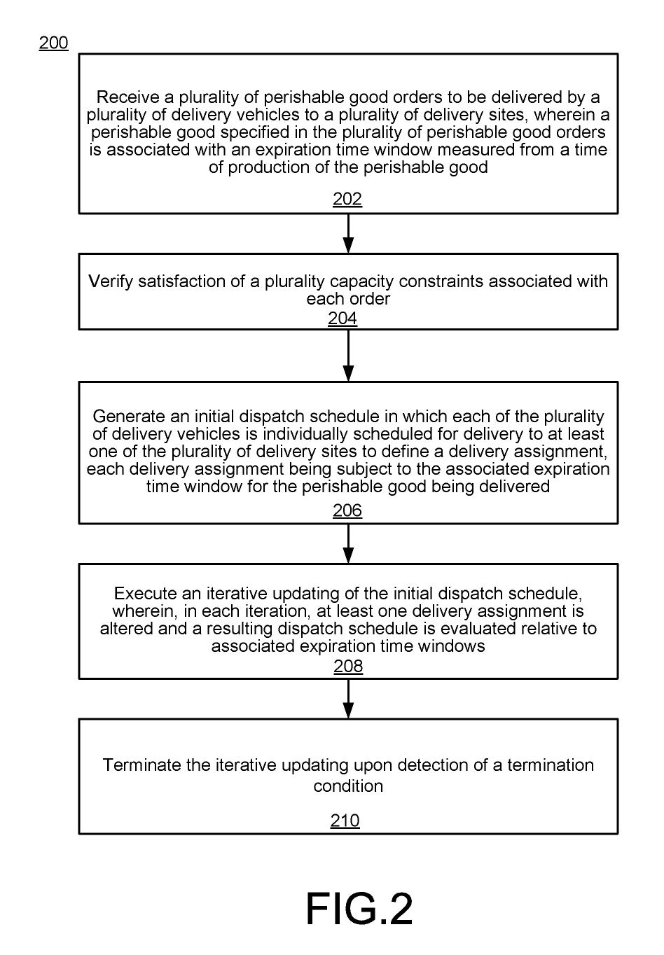

FIG. 2 is a flowchart 200 illustrating example operations of the system 100 of FIG. 1. In the example of FIG. 2, operations 202-210 are illustrated as separate, sequential operations. However, in various implementations, additional or alternative operations may be included, and any two or more such operations or sub-operations may be executed in a partially or completely overlapping or parallel manner, or in a nested, iterative, looped, or branched fashion. Moreover, in such implementations, one or more of the operations 205-210 may be omitted.

In the example of FIG. 2, a plurality of perishable good orders to be delivered by a plurality of delivery vehicles to a plurality of delivery sites may be received, wherein a perishable good specified in the plurality of perishable good orders is associated with an expiration time window measured from a time of production of the perishable good (202). For example, the dispatch schedule manager 102, e.g., the capacity verifier 128, may initially receive one or more orders associated with one or more of the delivery sites 112-118. In various implementations, the orders may be received one by one and acted upon immediately, may be received in batches, or may be received one by one but stored for batch processing thereof. In some implementations, the various orders may relate to various different types of perishable goods, where each associated, relevant expiration time window may be stored, e.g., within the inventory database 122. In some implementations, the received orders may not be in a format compatible for processing in conjunction with the various databases 120-126 (e.g., may include more or fewer fields than required, or may use alternative semantics or terminology), and may therefore have to be filtered or otherwise processed for subsequent handling within the dispatch schedule manager 102.

For each order, satisfaction of a plurality capacity constraints associated therewith may be verified (204). For example, the capacity verifier 128 may be configured to compare order data received with respect to the various orders and stored within the order database 120 with corresponding relevant data obtained from the inventory database 122 and the vehicle database 124. As long as the capacity verifier 128 ensures that it is at least feasible to construct a dispatch schedule that fulfills the available orders using currently-available resources (or resources available at a time of the dispatch scheduling), then operations of the dispatch schedule manager 102 may proceed.

Specifically, as referenced above and described in more detail below, an initial dispatch schedule in which each of the plurality of delivery vehicles is individually scheduled for delivery to at least one of the plurality of delivery sites to define a delivery assignment may be generated, each delivery assignment being subject to the associated expiration time window for the perishable good being delivered (206). For example, the dispatch schedule generator 130 may generate a plurality of delivery assignments for the orders being processed and using one or more of any available delivery vehicles. As described herein, the dispatch constraint verifier 132 may be configured to ensure that the initial dispatch schedule conforms to the various dispatch constraints, including compliance with the expiration time window.

An iterative updating of the initial dispatch schedule may then be executed, wherein, in each iteration, at least one delivery assignment is altered and a resulting dispatch schedule is evaluated relative to associated expiration time windows (208). For example, the dispatch schedule optimizer 134 may be configured to randomly alter aspects of the various delivery assignments, e.g., may alter a delivery vehicle associated with the particular delivery site, or conversely, may alter a delivery site associated with one or more delivery vehicles.

The dispatch schedule optimizer 134 may use additional or alternative techniques for altering the initial or current dispatch schedule, including, e.g., genetic algorithms. For example, the various delivery assignments may be used as chromosomes in genetic algorithms. In each case, the dispatch constraint verifier 132 may be configured to evaluate the newly-altered dispatch schedule of the current iteration, and thereby ensure that all dispatch constraints, including compliance with associated expiration time windows, will be met.

As referenced above, if the resulting dispatch schedule is an improvement over a currently-best available dispatch schedule, then the dispatch schedule may be saved to the schedule database 126. If the current dispatch schedule is not an improvement over preceding dispatch schedules, then it may be discarded. If the dispatch schedule does not comply with the various dispatch constraints, then the dispatch schedule also may be discarded. Additionally, in such scenarios, the dispatch schedule optimizer 134 may consider delivery assignments found to have violated the various dispatch constraints as a starting point for making subsequent alterations to delivery assignments for the next subsequent iteration.

The iterative updating may be terminated upon detection of a termination condition (210). For example, as already referenced, such termination conditions may include, for example, a detection of a certain number of iterations having been completed, or a compliance with a previously-specified cost threshold or other metric. Additionally or alternatively, the termination condition may be specified with respect to a total time of executing the various iterations, where, in some examples, the relevant time limit may be dictated by deadlines imposed within one or more of the orders being processed.

FIG. 3 is a flowchart illustrating more detailed example operations of the system 100 of FIG. 1. In the example of FIG. 3, an order is received (302). For example, as described above, one or more orders may be accessed from within the order database 120. Additionally, or alternatively, orders may be received and processed in real-time at the dispatch schedule manager 102.

The capacity verifier 128 may then examine the order and extract data related to capacity verifications to be performed. For example, the capacity verifier 128 may extract a number of units, a total weight or volume, or other metric characterizing a quantity of the order being requested. Then, in the example of FIG. 3, the capacity verifier 128 may proceed to verify that a sufficient quantity of relevant inventory exists within the inventory database 122, and can be supplied in a required form and within a required time specified within the received order (304).

If sufficient inventory cannot be verified, then the order will be refused (306). On the other hand, if sufficient inventory is verified, the capacity verifier 128 may proceed to verify the existence of sufficient production capacity to provide the verified inventory in a form, manner, and timing required for subsequent delivery thereof, including accessing the inventory database 122. Consequently, the capacity verifier 128 may proceed to execute such production capacity verification (308), and again will cause refusal of the order (306) if sufficient production capacity does not exist. In general, as described herein, such production capacity may refer to an assembly or other preparation of raw inventory goods, a loading of the raw goods into an appropriate one of the delivery vehicles 106-110, and any other production operations associated with preparing ordered goods for delivery.

In a final example of operations of the capacity verifier 128, sufficient delivery capacity for the order in question may be verified (310), e.g., using the vehicle database 124. For example, the capacity verifier 128 may verify that a sufficient number of delivery vehicles, having sufficient delivery capacity, will be available at a time sufficient to permit delivery of the ordered goods, while taking into account distances between the depot 104 and the one or more delivery sites 112-118, intervening traffic conditions, and other factors that may inhibit or delay the requested delivery. As with the preceding capacity verifications, failure to verify the necessary delivery capacity will result in order refusal (306).

Thus, the capacity verifier 128 ensures that minimum capacities exist for fulfilling the order in question. In subsequent operations of the dispatch schedule manager 102, individual delivery assignments scheduling one or more delivery vehicles 106-110 for delivery at one or more scheduled times to one or more of the delivery sites 112-118 are formulated, optimized, and stored within the schedule database 126. For example, as described herein, the dispatch schedule generator 130 may be configured to generate an initial solution for a desired dispatch schedule (312). In some example implementations, initial delivery assignments may be made by randomly matching delivery vehicles having sufficient capacity to deliver the ordered goods within the specified timeframe. In other example implementations, specific techniques may be selected to generate the initial dispatch schedule. For example, the dispatch schedule generator 130 may initially select delivery vehicles having lower unit costs. In other examples, in which the goods to be delivered will exceed a capacity of the largest of the available delivery vehicles, the dispatch schedule generator 130 may initially select the largest of the available delivery vehicles to be included in a first delivery assignment, and then proceed by selecting successfully smaller delivery vehicles.

Once the initial dispatch schedule has been generated, the dispatch constraint verifier 132 may proceed to verify that the dispatch schedule and associated delivery assignments fulfill all required dispatch constraints (314). If the dispatch constraints cannot be verified for the individual delivery assignments of the initial dispatch schedule, then an iterative optimization may continue (316), in which the initial dispatch schedule is modified, and the resulting, modified dispatch schedule is itself subjected to dispatch constraint checking (314). On the other hand, if the dispatch constraints in a given iteration of the optimization process do satisfy the dispatch constraints, then a termination condition may be assessed (318). If the termination condition has not been met at the given iteration, the iterative to optimization may continue (316).

Otherwise, if the termination condition has been met, then the best available dispatch schedule will be written to the schedule database 126 (320), and the order will be accepted (322). That is, in some example implementations, and dependent upon the termination condition being used, the selected schedule optimization may include the dispatch schedule provided in the most recent iteration of the iterative optimization process. In other example implementations, as described in detail below, the selected dispatch schedule stored within the schedule database 126 will include the best available schedule dispatch discovered during the iterative optimization process.

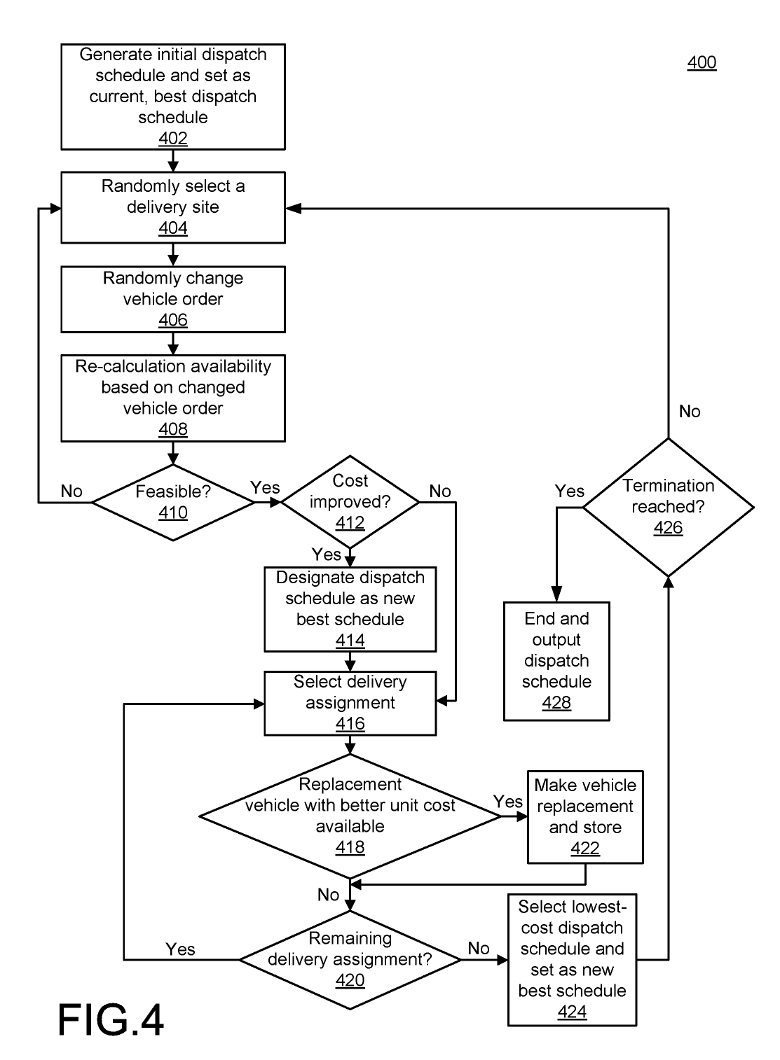

FIG. 4 is a flowchart illustrating more detailed example operations of the iterative optimizations referenced above with respect to FIGS. 1-3. The example of FIG. 4 is described in yet more detail in the context of FIGS. 5 and 6, and with reference to an example implementation of the system 100 of FIG. 1 used to provide dispatch scheduling for concrete deliveries.

In the example of FIG. 4, an initial dispatch schedule is generated and set as a current, best dispatch schedule (402). As referenced above, such initialization ensures a feasible dispatch schedule of delivery assignments, that is unlikely to provide an optimal or near optimal dispatch schedule. A more specific example of an initialization algorithm for generating an initial dispatch schedule in the context of concrete delivery is provided below, in conjunction with FIGS. 5 and 6.

In the remainder of FIG. 4, optimization operations are provided for optimizing dispatch schedules based on minimization of associated costs. Of course, in other example implementations, other optimization criteria may be used.

In various implementations, costs may be characterized in an appropriate manner. For example, in the following examples of FIGS. 5 and 6, in the context of concrete delivery, costs associated with raw material, production, loading, pouring, and washing be the concrete delivery trucks generally do not change appreciably in conjunction with changes to dispatch scheduling. In these and similar contexts, therefore, costs may be characterized with sufficient accuracy using a total transportation cost of each delivery assignment. Even so, different delivery vehicles, e.g., different types of trucks, have different transportation costs, so that variations in selected dispatch schedules will cause variations in availabilities of the different delivery trucks, which, in turn, restricts and defines a solution space of possible delivery assignments within selected dispatch schedules.

In the following example of FIG. 4, the optimization strategy generally considers the initial dispatch schedule and modifies a relationship of a delivery vehicle and/or an associated delivery site, and/or alters an order in which delivery vehicles are assigned for delivery to one or more delivery sites. More specifically, in the example of FIG. 4, a delivery site may be randomly selected (404), and a vehicle order for delivery to the delivery site may be randomly changed (406). Availability of delivery vehicles may then be recalculated, as compared to the initial dispatch schedule, based on the change vehicle order (408).

In some example implementations, availability may be recalculated using some or all of availability techniques used to generate the initial dispatch schedule as a feasible dispatch schedule. Again, specific examples of such availability verification are referenced above with respect to FIG. 3, and described in more detail below, with respect to FIGS. 5 and 6.

If the updated delivery schedules are not feasible (410), then random selections and changes to delivery sites and/or vehicle order may be executed again (404, 406), thereby allowing a determination as to whether a feasible dispatch schedule has been generated (408, 410). Once a feasible dispatch schedule has been generated, a cost of the current dispatch schedule may be compared to the initial dispatch schedule (412). If the cost has been relatively improved, then the new dispatch schedule may be designated as the current, best schedule (414). For example, the dispatch schedule optimizer 134 may update the schedule database 126 with the new, current best schedule.

If the cost of the updated dispatch schedule has not improved as compared to the initial dispatch schedule (412), it is still possible that the updated dispatch schedule may be improved (e.g., costs may be lowered), e.g., based on the fact that the random changes to the initial dispatch schedule may have caused differences in vehicle availabilities that may be leveraged to lower the overall cost of the dispatch schedule. In order to verify whether such cost reductions may be possible, the dispatch schedule optimizer 134 may be configured to scan the entire, current dispatch schedule, and individually consider each delivery assignment thereof to determine whether one or more delivery vehicles of each delivery assignment may be replaced by the different delivery vehicle having a lower unit cost. For example, changing a vehicle order in the initial dispatch schedule (406) may result in a delivery vehicle having availability in the context of the updated dispatch schedule, that would not have been available within the initial dispatch schedule.

Thus, in FIG. 4, the updated dispatch schedule obtained from the random changes to the delivery assignments described above may represent a cost optimization, based purely on such random changes, as referenced above (414). Whether such cost improvements are reached in this context or not, the dispatch schedule optimizer 134 may be configured to attempt to obtain additional cost improvements by selecting an individual delivery assignment (416), as just referenced. As also just referenced, if a replacement vehicle with an improved unit cost is available for use within the selected delivery assignment (418), then the dispatch schedule optimizer 134 may proceed to make the vehicle replacement and store the resulting, updated dispatch schedule within the schedule database 126.

Once completed, or if no replacement vehicle with a better unit cost is available, the dispatch schedule optimizer 134 may determine whether any delivery assignments remain within the current dispatch schedule (420). If so, selection of subsequent delivery assignments may be made (416) along with subsequent determination as to whether one or more replacement vehicles are available for use within the selected delivery assignments (418).

At the end of these iterative operations, it is possible that a single, updated dispatch schedule is stored in the schedule database 126, which may then be set as a new, best dispatch schedule for use in subsequent iterations (424). In other iterations, the schedule database 126 may possibly fail to store any dispatch schedule that represents an improvement over the initial dispatch schedule. In such cases, if a termination condition has not been reached (426), then the above-described random changes to the dispatch schedule, and associated availability verification and subsequent operations, may be executed, until the termination condition is reached (426), and a final dispatch schedule is provided (428).

In other example implementations, it is possible that changes to the selected delivery assignments of a current dispatch schedule being processed will result in two or more dispatch schedules having lower costs than the initial dispatch schedule and/or the updated dispatch schedule from operation 414 (if applicable). In such cases, the dispatch schedule optimizer 134 may be configured to select the lowest cost dispatch schedule for use as the new, best dispatch schedule to be stored within the schedule database 126 and used in subsequent operations and iterations of the flowchart 400.

As referenced above, the termination condition of operation 426 may be set in an appropriate manner. For example, the termination condition may check whether a cost of the current dispatch schedule has reached a predefined level. In other example implementations, the termination condition may verify whether the dispatch schedules being provided do not change (or do not change significantly) after a certain number of iterations, such as 100 iterations, or 1000 iterations. In still other implementations, the termination may occur after some predefined number of iterations.

As also referenced above, operations of the flowchart 400 may be parallelized. For example, multiple processes/threads may be used to execute operations 404-424, while keeping a single best solution stored within the schedule database 126. Further, during re-optimization processes, a current, best dispatch schedule may be used as an initial dispatch schedule during subsequent iterations of the flowchart 400.

As referenced above, FIG. 5 is a timing diagram 500 illustrating an implementation context of the systems and methods of FIGS. 1-4, in the context of concrete delivery. As also referenced above, concrete is typically produced at a concrete factory, and delivered to construction job sites using a concrete mixer truck. Even within a concrete mixer truck, concrete to be delivered will harden over time, so that the concrete represents a perishable good that should be delivered as quickly as possible upon its production.

When a delivery requirement for concrete is large, such as a single large order for a single delivery site, or a single large order for two or more delivery sites, or simply a large number of orders from different customers of a single concrete supplier, it is difficult or impossible to dispatch and schedule concrete deliveries without associated waste (e.g., without hardening of concrete within a mixer truck and prior to successful delivery thereof). Thus, FIG. 5 illustrates a timing diagram 500 demonstrating complexities of concrete delivery workflows. As shown, a concrete mixer truck 501 is used to execute a delivery assignment of concrete to a delivery site 502. As also as shown, an initial production time 503 of 10:15 begins a 3-minute production time 504, followed by a 6-minute loading time 506, in which the concrete is loaded into the mixer truck 501.

An outward transportation time 508 of 36 minutes enables an initial pouring time 510 of 11:00, which is followed by a pouring time 512 of 25 minutes at the delivery site 502. At the end of the pouring time 512, a returning time 514 of 23 minutes is experienced by the concrete mixer truck 501. Upon arrival at the original depot, a washing time 516 for washing the concrete mixer 501 in preparation for subsequent delivery is experienced, and illustrated as lasting for 3 minutes in the example. Consequently, a completed time 518 at which the concrete mixer truck 501 is again available for a subsequent concrete delivery is illustrated in FIG. 5 as 11:51.

In practice, the loading, transportation, pouring, returning, and washing times are necessary, but may vary in duration in different contexts. Sometimes the concrete mixer truck must wait, e.g., for production or pouring to occur. Moreover, different delivery sites may require different types of concrete, so that a duration of each window of time in FIG. 5 may be different in different contexts.

As also referenced above, different models trucks, with different capacities and unit transportation cost, may exist. Further, in the context of concrete delivery, it often occurs that single delivery sites will require large volumes of concrete that cannot be delivered by a single mixer truck. Since the concrete hardens over time, if such a plurality of trucks are dispatched to a single job site, the trucks must arrive within appropriate time windows for preventing concrete hardening, while waiting for preceding trucks to be unloaded.

Thus, the example context of FIG. 5 illustrates a scenario in which it is often beyond human capability to process known dispatch/scheduling data, and related data, to obtain optimized dispatch schedules. In particular, it would be appreciated that orders received from one or more customers for concrete deliveries may be too illuminous, too detailed, and/or received too quickly for manual processing. In contrast, as described, the system 100 of FIG. 1 may quickly provide optimized dispatch schedules that minimize or eliminate concrete spoilage and associated costs, while lowering an overall delivery cost.

As described above, operations of the system 100 and optimizing dispatch scheduling may begin upon receipt of one or more orders for delivery, which, in the context of the concrete delivery example of FIGS. 5 and 6, will contain information regarding a required volume of concrete, a type of concrete, and other concrete-specific terms, in addition to standard delivery parameters, such as delivery time, delivery site location, and price.

To perform the various verifications described above with respect to FIG. 3 (e.g., 304, 308, 310), the capacity verifier 128 may access the order database 120, the inventory database 122, and the vehicle database 124. With respect to inventory, in the context of concrete, raw materials include paste, aggregates, rocks, and water, where differences between different types of concrete may be defined, e.g., with respect to different ratios between the various raw materials. Consequently, inventory checking may be performed by verifying a quantity of inventory of each raw material. Meanwhile, a production time of concrete is usually relatively short, compared to the transportation time. Therefore, in this example, a transportation time between the depot (e.g., factory) and delivery site may be estimated, taking into account both distance and real-time traffic status, and including a buffer time (e.g., 10%), to reflect an anticipated or potential transportation time delays.

Then, a production time may be calculated from a total required production time, minus the estimated transportation time. With respect to delivery capacity verification, the capacity verifier 128 may access the estimated production time just calculated, and determine from the vehicle database 124 whether sufficient quantities of delivery capacities of delivery vehicles will be available at a necessary time.

Then, in order to move forward with the iterative optimization process, relevant constraints may be identified. For example, the inventory, production capacity, and delivery capacity must be enough for all accepted orders. For each order, the first concrete mixer truck should arrive no later than the calculated required time to begin production. The duration between the production time and the pouring time (e.g., between the time 503 and the end of the time 512) must be shorter than the hardening time for the concrete being delivered. Further, a mixer truck may only be dispatched to a single location at a given time. As a final example of a constraint, delivery by multiple trucks may be required (depending on relative delivery capacities of the trucks and order volumes of concrete), in which case the pouring operation should be relatively continuous, without intervening intervals between completion of pouring by the first delivery truck and commencement of pouring by the second delivery truck. In other words, in order to avoid pouring concrete when a preceding concrete delivery has already begun hardening, the second delivery truck should pour its concrete within a predefined time window (e.g., 20 minutes) after completion of a preceding truck's pouring.

Considering these and other applicable constraints, the dispatch schedule generator 130 may proceed to generate an initial solution. In the example, an initialization algorithm may be used which initially selects delivery trucks from the available delivery truck set defined within the vehicle database 124. Then, a departure time may be assigned for each delivery truck, and a return time (i.e., a time at which the truck becomes available again) may be calculated.

For selecting delivery trucks from an available truck set, trucks with relatively lower unit costs may be selected first. Generally, as referenced above, larger trucks may have a lower unit cost, as compared to smaller trucks. Thus, the dispatch schedule generator 130 may initially schedule a dispatch of a smallest truck having a capacity larger than or equal to a required volume.

For example, if the three delivery trucks 106, 108, 110 of FIG. 1 have volume/capacities of 5 m³, 7 m³, and 10 m³, and if the order requires 6 m³ of concrete, the 7 m³ truck would be selected first. If the required volume of concrete is larger than any of the individual trucks, the largest trucks will be schedule for dispatch, until the remaining volume of concrete can be loaded into a smaller delivery truck. For example, if the job site requires 21 m³ of concrete, two trucks having 10 m³ capacities may be scheduled for dispatch, along with one truck having 5 m³ of capacity.

For assigning a departure time for each truck, the largest trucks may be dispatched, followed by the smaller trucks. As referenced, the departure time may be determined using an estimated transportation time for the road or traffic in question. For example, with reference to FIG. 5, if the delivery site wishes to begin pouring at 11:00 .am., and a transportation time between a factory and the delivery site is 40 minutes, then the first truck must depart no later than 10:20 a.m. With the above-referenced 10% buffer time for unexpected traffic, the departure time may be scheduled at 4 minutes, e.g., 10:16 a.m.

If the pouring time is 25 minutes, as shown, a subsequent truck will depart 25 minutes after departure of the first truck. Again allowing for a 10% buffer, the next truck would thus depart 21 minutes after the previous truck's departure.

FIG. 6 is a Gantt chart that provides an example technique for verifying an availability of a given truck at a given point in time. As shown, FIG. 6 illustrates an example of a Gantt chart for the use of six different delivery trucks. As shown, a first truck 602 departs at 10:15, delivers its load of concrete, and returns and is available for subsequent deliveries as of 12:05. A second truck 604 departs at 10:45, and is available for subsequent delivery at 12:25. A third truck 606 departs at 10:55, and is available for subsequent delivery at 12:05. A fourth truck 608 departs at 11:05 and is available for subsequent delivery at 12:55. A fifth truck 610 departs at 11:25 and is available for subsequent delivery at 1:30. Finally, a sixth truck 612 departs at 11:35 a.m., and is available for subsequent delivery at 1:20, as well. Thus, FIG. 6 illustrates a convenient technique for judging relative availabilities of the delivery trucks, so as to verify availability constraints, which can be used during the optimization processes of, e.g., FIG. 4.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a non-transitory computer-readable storage medium and comprising instructions that, when executed, are configured to cause at least one computing device to:
receive a plurality of perishable good orders to be delivered by a plurality of delivery vehicles to a plurality of delivery sites, wherein a perishable good specified in the plurality of perishable good orders is associated with an expiration time window measured from a time of production of the perishable good;
verify, for each order, satisfaction of a plurality of capacity constraints associated therewith;
generate an initial dispatch schedule in which each of the plurality of delivery vehicles is individually scheduled for delivery to at least one of the plurality of delivery sites to define a delivery assignment, each delivery assignment being subject to the associated expiration time window for the perishable good being delivered;
execute an iterative updating of the initial dispatch schedule wherein, in each iteration, at least one delivery assignment is altered and a resulting dispatch schedule is evaluated relative to associated expiration time windows; and
terminate the iterative updating upon detection of a termination condition.

2. The computer program product of claim 1, wherein the instructions, when executed, are further configured to cause the at least one computing device to:
verify the satisfaction of the plurality of capacity constraints for each order including accessing at least one database including inventory data for the perishable good, production data for the perishable good, and vehicle capacity data for the plurality of delivery vehicles.

3. The computer program product of claim 1, wherein the instructions, when executed, are further configured to cause the at least one computing device to:
verify the satisfaction of the plurality of capacity constraints including determining an inability to satisfy at least one of the plurality of capacity constraints for at least one of the plurality of orders; and
refuse the at least one of the plurality of orders based on the inability.

4. The computer program product of claim 1, wherein the instructions, when executed, are further configured to cause the at least one computing device to:
generate the initial dispatch schedule including creating delivery assignments based on relative unit costs for individual ones of the plurality of delivery vehicles.

5. The computer program product of claim 1, wherein the instructions, when executed, are further configured to cause the at least one computing device to:
generate the initial dispatch schedule including defining an initial order of delivery for each of the plurality of delivery vehicles with respect to the plurality of delivery sites.

6. The computer program product of claim 5, wherein the instructions, when executed, are further configured to cause the at least one computing device to:
execute the iterative updating including altering the at least one delivery assignment, including
randomly changing a delivery site of the at least one delivery assignment;
randomly changing the initial order of delivery; and
re-calculating availabilities for the plurality of delivery vehicles, based on the randomly changed delivery site and the randomly changed initial order of delivery.

7. The computer program product of claim 6, wherein the instructions, when executed, are further configured to cause the at least one computing device to:
execute the iterative updating including altering the at least one delivery assignment, including
determining that the re-calculated availabilities do not satisfy dispatch constraints;
randomly selecting a second delivery site of the plurality of delivery sites;
randomly changing a current order of delivery; and
re-calculating availabilities for the plurality of delivery vehicles, based on the randomly changed second delivery site and the randomly changed current order of delivery.

8. The computer program product of claim 6, wherein the instructions, when executed, are further configured to cause the at least one computing device to:
execute the iterative updating including altering the at least one delivery assignment, including
determining that the re-calculated availabilities satisfy dispatch constraints;
determining that a cost of the altered dispatch schedule is lower than the initial dispatch schedule; and
replacing the initial dispatch schedule within a schedule database with the altered dispatch schedule.

9. The computer program product of claim 6, wherein the instructions, when executed, are further configured to cause the at least one computing device to:
scan delivery assignments of the dispatch schedule, based on the re-calculated availabilities, to determine whether, for a selected delivery assignment, a replacement delivery vehicle with a lower unit cost is available for inclusion within the selected delivery assignment.

10. The computer program product of claim 1, wherein the termination condition includes a cost threshold, and the iterative updating is terminated when the cost threshold is reached for a current dispatch schedule.

11. A method, comprising:
receiving a plurality of perishable good orders to be delivered by a plurality of delivery vehicles to a plurality of delivery sites, wherein a perishable good specified in the plurality of perishable good orders is associated with an expiration time window measured from a time of production of the perishable good;
verifying, for each order, satisfaction of a plurality of capacity constraints associated therewith;
generating an initial dispatch schedule in which each of the plurality of delivery vehicles is individually scheduled for delivery to at least one of the plurality of delivery sites to define a delivery assignment, each delivery assignment being subject to the associated expiration time window for the perishable good being delivered;
executing an iterative updating of the initial dispatch schedule wherein, in each iteration, at least one delivery assignment is altered and a resulting dispatch schedule is evaluated relative to associated expiration time windows; and
terminating the iterative updating upon detection of a termination condition.

12. The method of claim 11, wherein verifying the satisfaction of the plurality of capacity constraints for each order includes accessing at least one database including inventory data for the perishable good, production data for the perishable good, and vehicle capacity data for the plurality of delivery vehicles.

13. The method of claim 11, wherein:
generating the initial dispatch schedule includes defining an initial order of delivery for each of the plurality of delivery vehicles with respect to the plurality of delivery sites.

14. The method of claim 13, wherein executing the iterative updating including altering the at least one delivery assignment includes
randomly changing a delivery site of the at least one delivery assignment;
randomly changing the initial order of delivery; and
re-calculating availabilities for the plurality of delivery vehicles, based on the randomly changed delivery site and the randomly changed initial order of delivery.

15. The method of claim 14, wherein executing the iterative updating including altering the at least one delivery assignment includes
determining that the re-calculated availabilities do not satisfy dispatch constraints;
randomly selecting a second delivery site of the plurality of delivery sites;
randomly changing a current order of delivery; and
re-calculating availabilities for the plurality of delivery vehicles, based on the randomly changed second delivery site and the randomly changed current order of delivery.

16. The method of claim 14, wherein the iterative updating comprises:
executing the iterative updating including altering the at least one delivery assignment, includes
determining that the re-calculated availabilities satisfy dispatch constraints;
determining that a cost of the altered dispatch schedule is lower than the initial dispatch schedule; and
replacing the initial dispatch schedule within a schedule database with the altered dispatch schedule.

17. The method of claim 14, wherein the iterative updating comprises:
scanning delivery assignments of the dispatch schedule, based on the re-calculated availabilities, to determine whether, for a selected delivery assignment, a replacement delivery vehicle with a lower unit cost is available for inclusion within the selected delivery assignment.

18. A system including instructions recorded on a non-transitory computer-readable storage medium, and executable by at least one processor, the system comprising:
a capacity verifier configured to access an inventory database and a vehicle database, based on at least one of a plurality of perishable good orders to be delivered by a plurality of delivery vehicles to a plurality of delivery sites, wherein a perishable good specified in the plurality of perishable good orders is associated with an expiration time window measured from a time of production of the perishable good;
a dispatch schedule generator configured to generate an initial dispatch schedule in which each of the plurality of delivery vehicles is individually scheduled for delivery to at least one of the plurality of delivery sites to define a delivery assignment, each delivery assignment being subject to the associated expiration time window for the perishable good being delivered, and further configured to access a schedule database to store the initial dispatch schedule;
a dispatch schedule optimizer configured to execute an iterative updating of the initial dispatch schedule wherein, in each iteration, at least one delivery assignment is altered and a resulting dispatch schedule is evaluated relative to associated expiration time windows, and further configured to access the schedule database and store a currently-best dispatch schedule, as compared to preceding iterations, and further configured to terminate the iterative updating upon detection of a termination condition.

19. The system of claim 18 wherein the initial dispatch schedule includes an initial order of delivery for each of the plurality of delivery vehicles with respect to the plurality of delivery sites.

20. The system of claim 19 executing the iterative updating including altering the at least one delivery assignment including
randomly changing a delivery site of the at least one delivery assignment;
randomly changing the initial order of delivery; and
re-calculating availabilities for the plurality of delivery vehicles, based on the randomly changed delivery site and the randomly changed initial order of delivery.
